(19) United States
(12) Patent Application Publication
(10) Pub. No.: US 2013/0159451 A1
(43) Pub. Date: Jun. 20, 2013

(54) SEMANTIC CACHE CLOUD SERVICES FOR CONNECTED DEVICES

(71) Applicant: William Luciw, Los Altos, CA (US)

(72) Inventor: William Luciw, Los Altos, CA (US)

(73) Assignee: Empire Technology Development, LLC, Wilmington, DE (US)

(21) Appl. No.: 13/522,016

(22) PCT Filed: Dec. 14, 2011
(86) PCT No.: PCT/US11/64844

§ 371 Date: Jul. 12, 2012

(51) Int. Cl. G06F 15/167

(52) U.S. Cl. 709/213

(57) ABSTRACT

Technologies are described for semantic cache for connected devices (semantic cache) as a set of next generation cloud services to primarily support the Internet of things scenario: a massive network of devices and device application services inter-communicating, facilitated by cloud-based semantic cache services. The semantic cache may be an instrumented caching reverse proxy with auto-detection of semantic web traffic, public, shadow and private namespace management and control, and real time semantic object temporal versioning, geospatial versioning, semantic contextual versioning and groupings and semantic object transformations.

### BACKGROUND

Unless otherwise indicated herein, the materials described in this section are not prior art to the claims in this application and are not admitted to be prior art by inclusion in this section.

The semantic web is a global web of linked data with shared public vocabulary ontologies and logical assertions on a wide variety of concepts and topics. Machines and humans are consumers of this web of inter-linked data, and various semantic web transmission formats may be employed to facilitate communication between the participants. However, for the Internet of things (interconnected devices in massive numbers beyond today's computers) to successfully utilize the semantic web, additional functionality, mechanisms, and services need to be added via cloud services in order to accommodate the myriad of massive numbers of inter-operating connected devices that depend on cloud services for intelligent device applications.

In order to support the intelligent device application demands of the Internet of things, the semantic web needs to scale massively, be secure, and be operationally manageable. The semantic web further needs to support the protection of intellectual property in the form of intelligent device applications, prevent unauthorized access and copying of device applications, and provide a trustworthy audit trail of application changes and data. Currently, the semantic web lacks the above-discussed capabilities, either completely or partially.

### SUMMARY

The present disclosure generally describes technologies for enabling interconnected devices in the Internet of things to communicate, applications to be executed, and intelligent services to be facilitated through cloud-based semantic cache services.

According to some embodiments, a method for providing semantic cache cloud services to connected devices may include receiving, by a caching reverse proxy server, web traffic from semantic device applications; selectively filtering the received web traffic; and automatically registering semantic objects representing semantic devices and semantic device applications into one or more namespaces. The method may also include instrumenting the received web traffic such that one or more of a time, a location, and a context for logical assertions are recorded, where the semantic objects are represented as a collection of logical assertions; and coordinating and synchronizing the semantic objects within a semantic object plexus representing cooperating semantic devices and semantic device applications.

According to other embodiments, a server for providing semantic cache cloud services to connected devices may include a memory adapted to store instructions, a communication module, and a processor adapted to communicate with the connected devices via one or more networks in conjunction with the stored instructions. The processor may receive web traffic from semantic device applications; selectively filter the received web traffic; automatically register semantic objects representing semantic devices and semantic device applications into one or more namespaces; instrument the received web traffic such that one or more of a time, a location, and a context for logical assertions are recorded, where the semantic objects are represented as a collection of logical assertions; and coordinate and synchronize the semantic objects within a semantic object plexus representing cooperating semantic devices and semantic device applications.

According to further embodiments, a computer-readable medium may include instructions stored thereon for providing semantic cache cloud services to connected devices. The instructions may include receiving, by a caching reverse proxy server, web traffic from semantic device applications; selectively filtering the received web traffic; automatically registering semantic objects representing semantic devices and semantic device applications into one or more namespaces; instrumenting the received web traffic such that one or more of a time, a location, and a context for logical assertions are recorded, where the semantic objects are represented as a collection of logical assertions; and coordinating and synchronizing the semantic objects within a semantic object plexus representing cooperating semantic devices and semantic device applications.

According to yet other embodiments, a system for providing semantic cache cloud services to connected devices may include a semantic cache service executed by one or more servers. The semantic cache service may include a semantic cache proxy service configured to one or more of register, identify, locate, track, and manage security of the connected devices' and/or connected device applications' metadata projection into a semantic cloud. The semantic cache service may also include a semantic cache interlock service configured to coordinate and synchronize semantic objects within a semantic object plexus that represents cooperating connected devices and connected device applications and a semantic cache transform service configured to provide transactional object transformations within and between interlocked semantic objects and/or semantic plexii.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example networked system of connected devices, where a semantic cache cloud service may be provided;

FIG. 2 illustrates an example configuration of a semantic cache cloud service provided by a semantic caching reverse proxy server employing different namespaces;

FIG. 3 illustrates example functional modules of a semantic cache service;

FIG. 4 illustrates a general purpose computing device, which may be used to implement a semantic cache cloud service;

FIG. 5 is a flow diagram illustrating an example method for providing a semantic cache service for connected devices such as the devices in FIG. 1;

FIG. 6 is a flow diagram illustrating an example method for employing a semantic cache service for connected devices such as the devices in FIG. 1; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to providing semantic cache cloud services to connected devices.

Briefly stated, technologies are described for semantic cache for connected devices (semantic cache) as a set of next generation cloud services to primarily support the Internet of things scenario: a massive network of devices and device application services inter-communicating, facilitated by cloud-based semantic cache services. The semantic cache may be an instrumented caching reverse proxy with auto-detection of semantic web traffic, public, shadow and private namespace management and control, and real time semantic object temporal versioning, geospatial versioning, semantic contextual versioning and groupings and semantic object transformations.

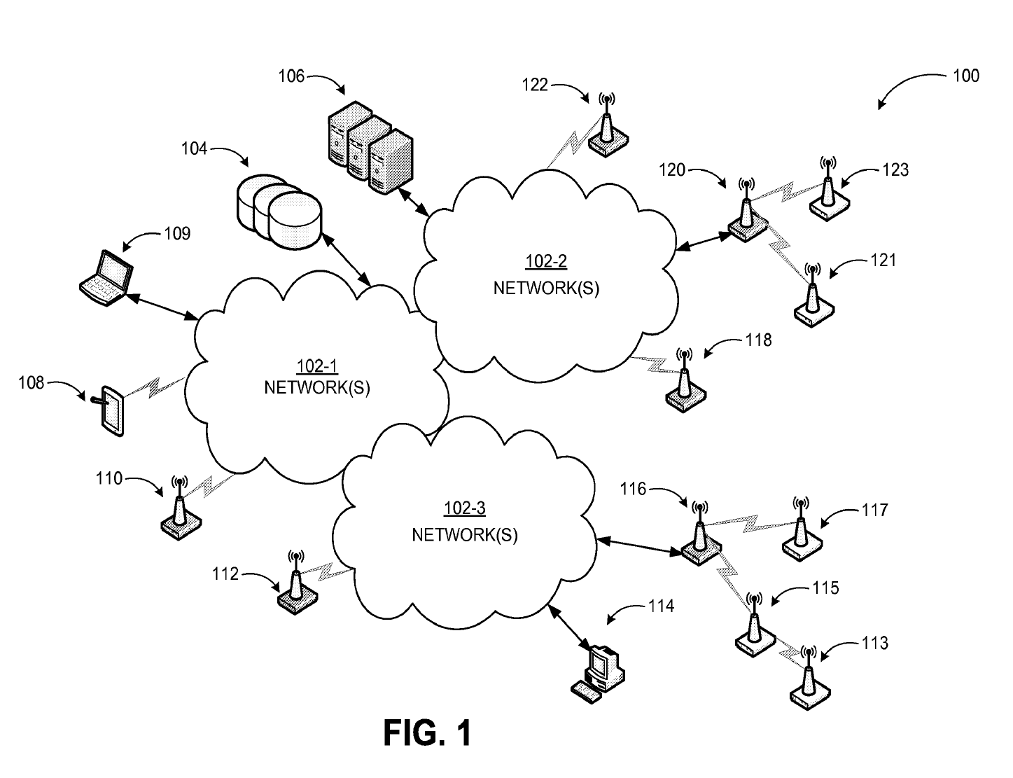

FIG. 1 illustrates an example networked system of connected devices, where a semantic cache cloud service may be provided, arranged in accordance with at least some embodiments described herein.

As shown in a diagram 100, a semantic web for the Internet of things or a massive realm of interconnected devices and applications may enable communication between devices and applications over multiple networks such as networks 102-1, 102-2, and 102-3. The networks 102-1, 102-2, and 102-3 may include wired, wireless, open, secure, public, private, and any form of network that can facilitate data exchange between connected devices.

A semantic cache service providing control and management of devices and applications in the described environment may utilize one or more data stores 104 and servers 106 in a distributed manner. In such an environment, the connected devices may include computing devices such as a laptop computer 109, a desktop computer 114, a portable computer 108, and any special purpose device (with any complexity) such as devices 110, 112, 116, 118, 120, and 122. Some devices may connect to the semantic web directly, while others may connect through one or more additional devices. For example, devices 121 and 123 may connect to the networked system through the device 120 and may be accessible (and their paths defined through) the device 120. Similarly, device 117 may connect to the networked environment through the device 116. Another scenario may be cascaded connection of devices such as device 113 connecting through device 115 and the device 116.

According to some embodiments, a caching reverse proxy service my receive web traffic from semantic device applications, selectively filter the received web traffic, and automatically register semantic objects representing semantic devices and semantic device applications into one or more namespaces. The semantic objects may be represented as a collection of logical assertions. The service may also instrument the received web traffic such that a time, a location, and a context for logical assertions are recorded and coordinate/synchronize the semantic objects within a semantic object plexus representing cooperating semantic devices and semantic device applications.

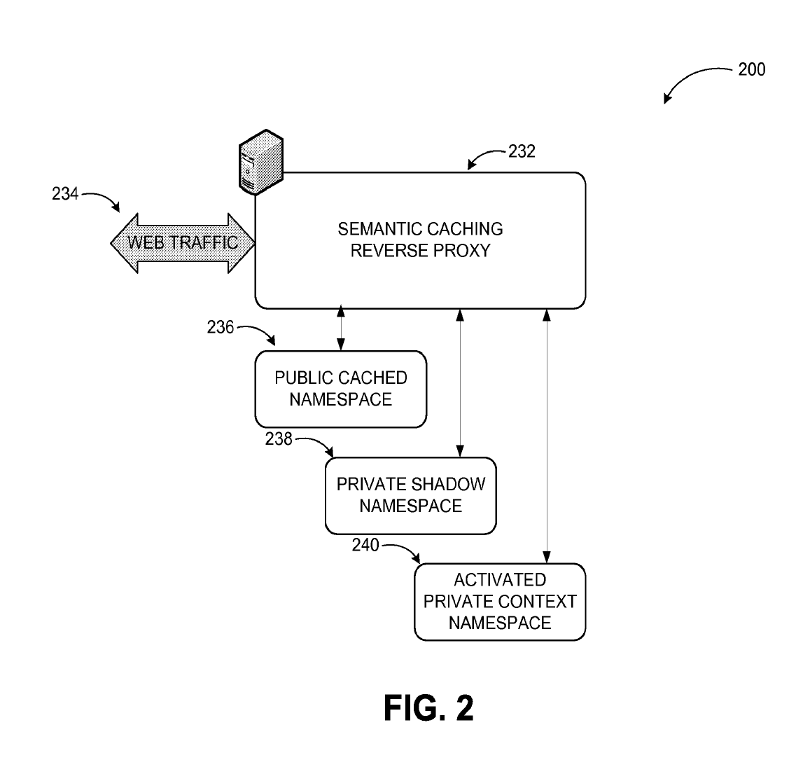

FIG. 2 illustrates an example configuration of a semantic cache cloud service provided by a semantic caching reverse proxy server employing different namespaces, arranged in accordance with at least some embodiments described herein.

A semantic cache for connected devices may be provided by utilizing a caching reverse proxy server 232 for web traffic 234. This means that semantic web requests from semantic device applications may be served directly by the semantic cache if available (semantic cache hit) or fetched from the semantic web of linked data (semantic cache miss) and then served from the semantic cache to the semantic device application. As shown in a diagram 200, the semantic web traffic 234 may be selectively filtered using dynamically created and updated lists of semantic web linked data namespaces (236, 238, and 240) using global public and private data registries such as a comprehensive knowledge archive network (CKAN). The semantic caching reverse proxy server 232 may automatically register semantic resources (e.g., URIs), cache, and proxy detected semantic web URI namespace traffic into three namespaces:

A public cached namespace 236 represents the semantic web linked data resources that are reachable. The semantic web may use a URI scheme to identify objects' (concepts) properties. As such, the URIs may identify a resource by name, in a particular namespace, the public cached namespace 236. Once accessed by the semantic cache, these resources may be cached, controlled, and managed via policies governing the semantic cache. A private shadow namespace 238 is a “shadow copy” of the public cached namespace 236, such that each semantic object referenced is automatically instrumented by temporal, geospatial, and contextual versioning and can contain additional hidden information. An activated private Q-context namespace 240 may be secured and opaque to users of the semantic cache. The Q-context includes a predefined set of objects, properties, and values that define assertions, queries, and rules relevant to an instrumented object. The activated private Q-context namespace 240 may contain, control, and manage all Q-context processing as discussed below.

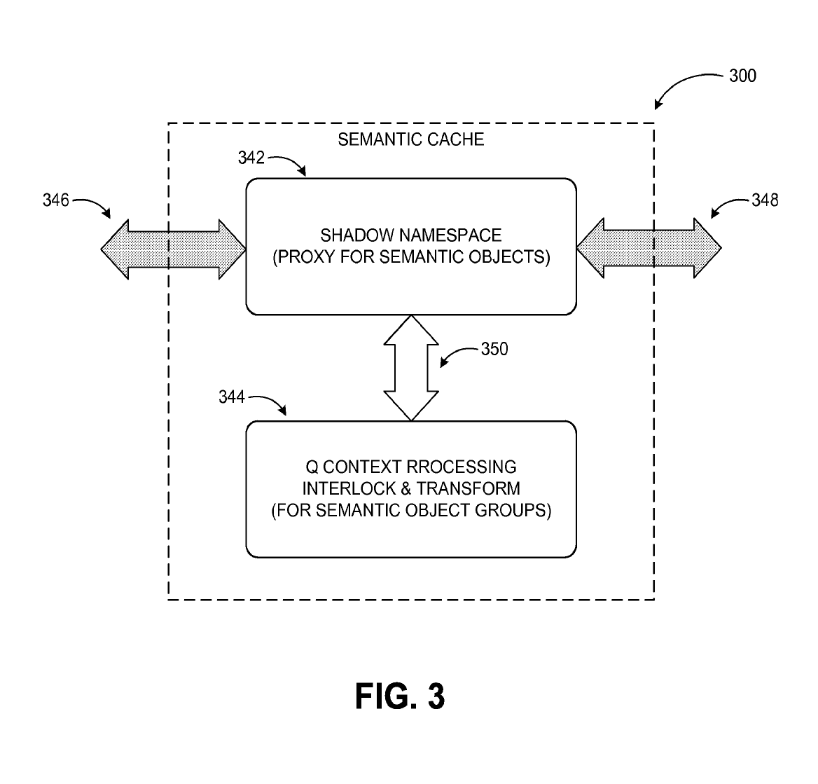

FIG. 3 illustrates example functional modules of a semantic cache service, arranged in accordance with at least some embodiments described herein.

A semantic cache may be a part of a broader notion of the semantic device cloud, i.e. intelligent services and applications for connected device object representation, communication, and manipulation of semantic metadata, aka semantic web device objects. The semantic cache may provide three major services: a semantic proxy, a semantic interlock, and a semantic transform. These core functions may enable key aspects of any semantic cloud device application, such as device management, secure in-field update, device application upgrade, and inter-operation with other devices.

The semantic cache proxy service may deal with the registration, identification, location, tracking and security of a given device's (or device application service's) metadata projection into the semantic cloud. The semantic cache interlock service may provide critical coordination and synchronization of composed semantic objects within a semantic object plexus (or plexii) representing the devices and device application services that are cooperating. The semantic cache transform service may provide secure, reliable, transactional object transformations within and between interlocked proxied semantic device objects and/or the semantic plexii.

Referring back to FIG. 3, a semantic cache 300 for connected devices may include a shadow namespace 342, which is a proxy for semantic objects, and a Q-context processing interlock and transform 344 for semantic object groups (plexus/plexii). The shadow namespace 342 may receive application transparent connected device web traffic 346 for semantic web linked data and provide proxied web traffic 348 for semantic web linked data sources. The shadow namespace 342 may also interact with the Q-context processing interlock and transform 344 for automatically triggered Q-context processing.

In a system according to some embodiments, the semantic objects may be represented as a collection of logical assertions in the form of: OBJECT-PROPERTY-VALUE, and the semantic web traffic may be instrumented so that TIME, LOCATION, and Q-CONTEXT are recorded for each logical assertion of OBJECT-PROPERTY-VALUE triples, constituting each semantic object. In the semantic object definition. OBJECT may refer to the URI reference to the semantic object, PROPERTY may be the URI reference to a property of the object in a given namespace, and VALUE may be a URI reference or any scalar or aggregate value.

The semantic cache 300 may automatically instrument each OBJECT-PROPERTY-VALUE assertion with: TIME-LOCATION-Q-Context assertions. Here TIME is a universal time designation with arbitrary precision; LOCATION is a set of geospatial coordinates of arbitrary precision that locates a shape (or point) in space; and Q-Context is an arbitrary set of objects, properties, and values that define the assertions, queries, and rules relevant to the instrumented OBJECT-PROPERTY-VALUE. These assertions, queries, and rules may be accessible via the Q-Context namespace.

Semantic cache 300 may apply Q-context processing by using the private Q-namespace, applying Q-contextual assertions, queries, and rules for interlock. A semantic plexus may then be created if arbitrarily specified interlock conditions are met. If interlock and semantic plexus have been achieved, the semantic cache 300 may perform on the semantic plexus using any of a variety of semantic web inference engines and logic reasoners as well as semantic web map-reduce frameworks. Because all processing is cached and bounded by the Q-context assertions, queries, and rules for every active semantic object plexus in a system according to embodiments, computation may be efficiently prioritized and optimized allowing for the efficient use of semantic web resources available.

For connected client semantic web device applications and end users, the semantic cache 300 may be used as follows: No special access or configuration may be needed beyond the semantic device application for semantic web traffic automatically detected via semantic web application use. Semantic device application services may be automatically detected. The semantic cache 300 may automatically optimize device application access and response based on the semantics of a device application in terms of the Q-context assertions, queries, and rules detected by the semantic cache 300 when the device application is first used, thus enabling a transparent Q-context processing based on a meaning of semantic web device application.

For semantic web device application developers work flow usage: semantic objects may be extended in private shadow namespace; secure semantic objects may be created in private Q-context namespace; Q-contexts may be created for semantic plexus interlock device object groups clustered by time, location proximity, Q-context value preconditions and thresholds; Q-context transform processing resources may be created such as rules and/or map-reduce transforms; and semantic objects may be registered by asserting them when semantic cache is active in network, explicitly or implicitly.

Cloud service operators may easily and transparently install highly-available semantic cache replicated clusters as part of public or private cloud. Semantic cache clusters may be replicated using efficient replication protocols. Alternatively or in addition, cloud service operators may bundle and subscribe to semantic cache cloud managed services available via third party cloud service operators.

For operational monitoring, semantic cache clusters may provide intelligent operational monitoring based on instrumentation of semantic web traffic and semantic device application semantics via Q-context processing. For operational management, semantic cache clusters may enforce intelligent operational management policies such as auditing, security, access control and copy protection based on semantic device application semantics via Q-context processing.

While embodiments have been discussed above using specific examples, components, scenarios, and configurations in FIG. 1 through FIG. 3, they are intended to provide a general guideline to be used for providing semantic cache cloud services to connected devices. These examples do not constitute a limitation on the embodiments, which may be implemented using other components, schemes, and configurations using the principles described herein.

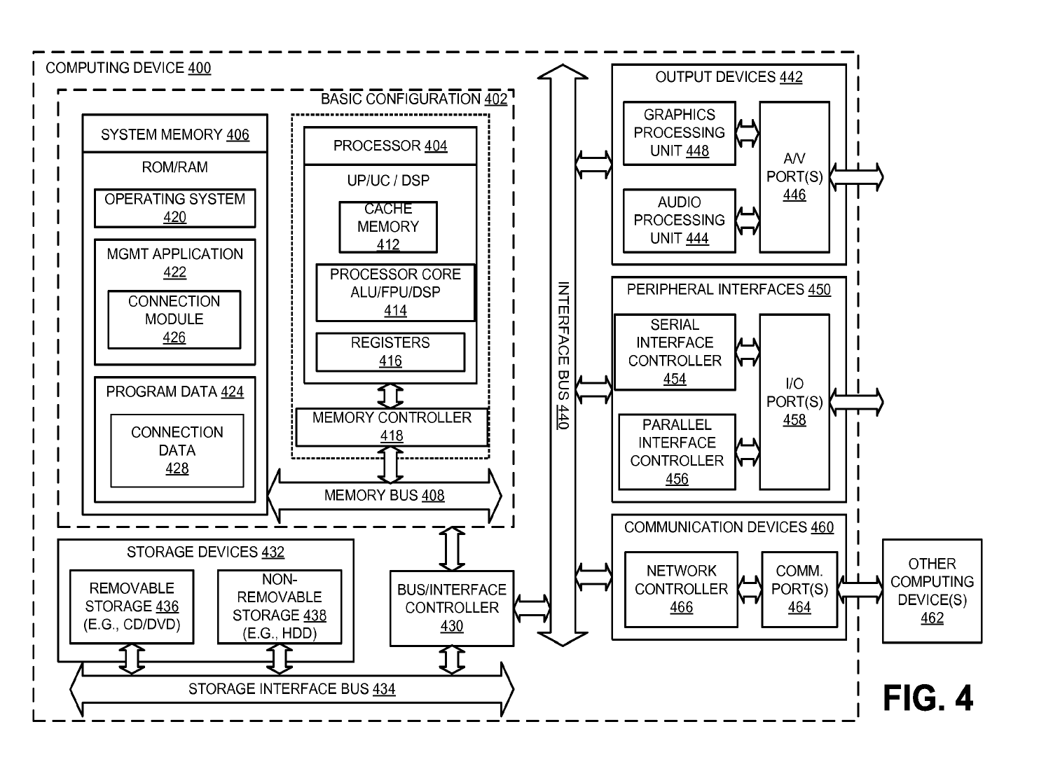

FIG. 4 illustrates a general purpose computing device, which may be used to implement a semantic cache cloud service, arranged in accordance with at least some embodiments described herein. In a very basic configuration 402, a computing device 400 may be a wireless mobile communication device and typically include one or more processors 404 and a system memory 406. A memory bus 408 may be used for communicating between the processor 404 and the system memory 406.

Depending on the desired configuration, the processor 404 may be of any type including but not limited to a microprocessor (μP), a microcontroller (μC), a digital signal processor (DSP), or any combination thereof. The processor 404 may include one more levels of caching, such as a level cache memory 412, a processor core 414, and registers 416. The example processor core 414 may include an arithmetic logic unit (ALU), a floating point unit (FPU), a digital signal processing core (DSP Core), or any combination thereof. An example memory controller 418 may also be used with the processor 404, or in some implementations a memory controller 415 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420 and a management application 422, which may include a connection module 426 for providing a semantic cache cloud service for connected devices as described herein. The system memory 406 may further include program data 424, a subset of which may be connection data 428. This described basic configuration 402 is illustrated in FIG. 4 by those components within the inner dashed line.

The computing device 400 may have additional features or functionality, and additional interfaces to facilitate communications between the basic configuration 402 and any required devices and interfaces. For example, a bus/interface controller 430 may be used to facilitate communications between the basic configuration 402 and one or more data storage devices 432 via a storage interface bus 434. The data storage devices 432 may be removable storage devices 434, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., output devices 442, peripheral interfaces 444, and communication devices 466 to the basic configuration 402 via bus/interface controller 430. The example output devices 442 include a graphics processing unit 448 and an audio processing unit 450, which may be configured to communicate to various external devices such as a display or speakers via one or more AN ports 452. The example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. The example communication devices 466 include a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations

Networks for a networked system including the computing device 400 may comprise any topology of servers, clients, switches, routers, modems, Internet service providers, and any appropriate communication media (e.g., wired or wireless communications). A system according to embodiments may have a static or dynamic network topology. The networks may include a secure network such as an enterprise network (e.g., a LAN, WAN, or WLAN), an unsecure network such as a wireless open network (e.g., IEEE 802.11 wireless networks), or a world-wide network such (e.g., the Internet). The networks may also comprise a plurality of distinct networks that are adapted to operate together. Such networks are configured to provide communication between the nodes described herein. By way of example, and not limitation, these networks may include wireless media such as acoustic, RF, infrared and other wireless media. Furthermore, the networks may be portions of the same network or separate networks.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

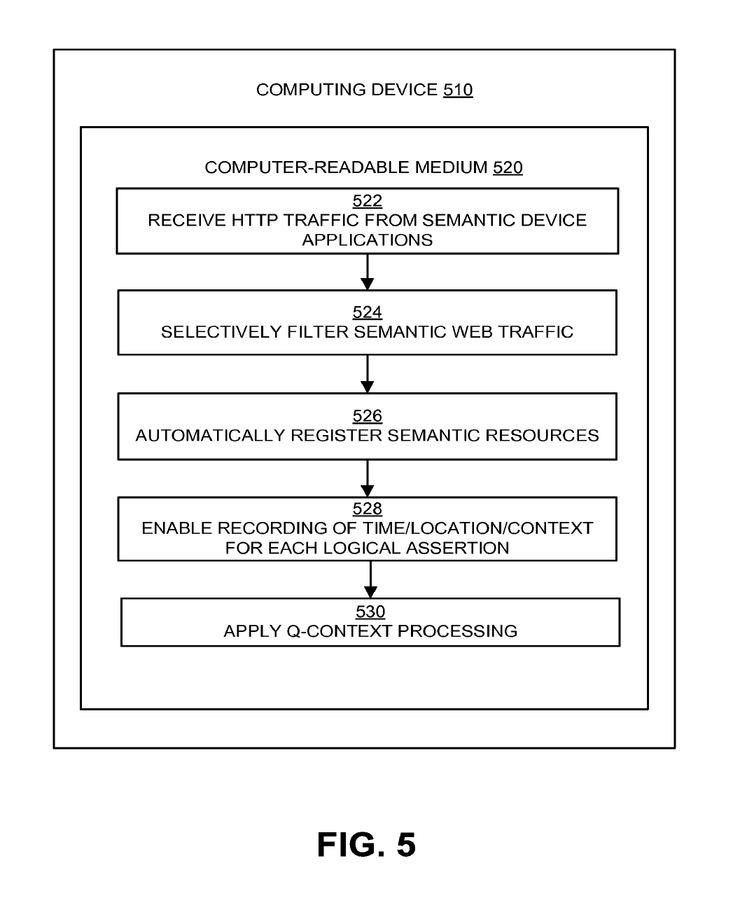

FIG. 5 is a flow diagram illustrating an example method for providing a semantic cache service for connected devices such as the devices in FIG. 1, arranged in accordance with at least some embodiments described herein. Example methods may include one or more operations, functions or actions as illustrated by one or more of blocks 522, 524, 526, 528, and/or 530. The operations described in the blocks 522 through 530 may also be stored as computer-executable instructions in a computer-readable medium such as a computer-readable medium 520 of a computing device 510.

An example process of providing a semantic cache service for connected devices may begin with block 522, “RECEIVE HTTP TRAFFIC FROM SEMANTIC DEVICE APPLICATIONS”, where a semantic cache application such as the management application 422 of FIG. 4 may receive web traffic associated with connected devices and applications in a semantic web environment. Block 522 may be followed by block 524, “SELECTIVELY FILTER SEMANTIC WEB TRAFFIC”, where the management application 422 may filter the received traffic using dynamically created and updated lists of semantic web linked data namespaces through global public and private data registries. Block 524 may be followed by block 526, “AUTOMATICALLY REGISTER SEMANTIC RESOURCES”, where the management application 422 may cache and proxy detected semantic web resources (e.g., their URIs) into three namespaces as discussed previously.

Block 526 may be followed by block 528, “ENABLE RECORDING OF TIME/LOCATION/CONTEXT FOR EACH LOGICAL ASSERTION”, where the management application may record the parameters for the objects through the OBJECT-PROPERTY-VALUE triples of the semantic objects. Block 528 may be followed by block 530, “APPLY Q-CONTEXT PROCESSING”, where Q-contextual assertions, queries, and rules may be applied using private Q-namespace for interlock.

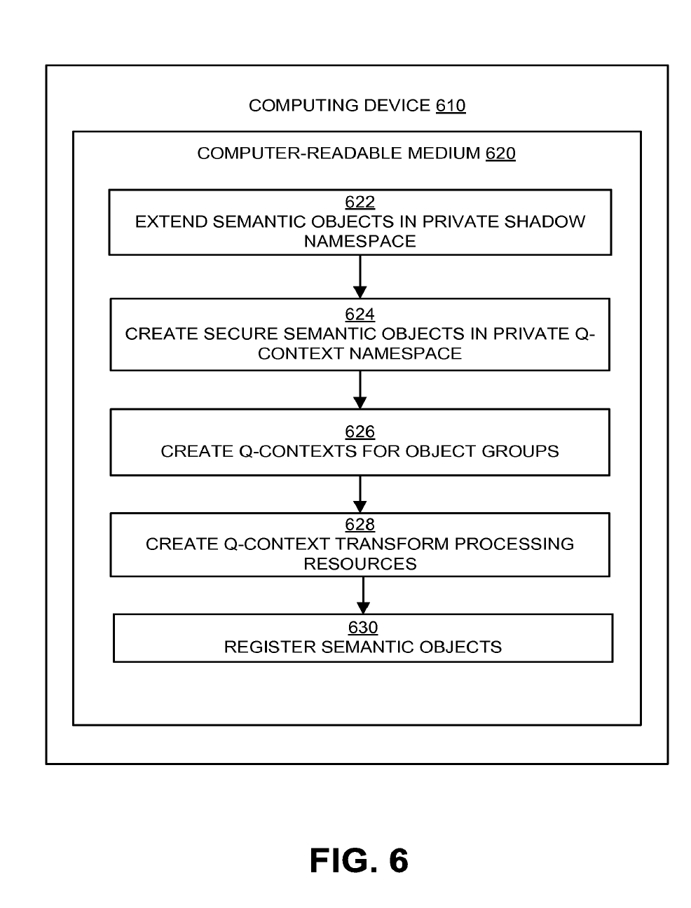

FIG. 6 is a flow diagram illustrating an example method for employing a semantic cache service for connected devices such as the devices in FIG. 1, arranged in accordance with at least some embodiments described herein. Example methods may include one or more operations, functions or actions as illustrated by one or more of blocks 622, 624, 626, 628, and/or 630. The operations described in the blocks 622 through 630 may also be stored as computer-executable instructions in a computer-readable medium such as a computer-readable medium 620 of a computing device 610.

An example process of employing a semantic cache service for connected devices may begin with block 622, “EXTEND SEMANTIC OBJECTS IN PRIVATE SHADOW NAMESPACE”, where semantic web device application developers may be enabled to extend the semantic objects in a private shadow namespace. Block 622 may be followed by block 624, “CREATE SECURE SEMANTIC OBJECTS IN PRIVATE Q-CONTEXT NAMESPACE”, where a private Q-context namespace may be used to create secure semantic objects.

Block 624 may be followed by block 626, “CREATE Q-CONTEXTS FOR OBJECT GROUPS”, where Q-contexts (assertions, rules, and queries) for semantic plexus interlock device object groups may be created clustered by time, location proximity, Q-context value preconditions, and thresholds. Block 626 may be followed by block 628, “CREATE Q-CONTEXT TRANSFORM PROCESSING RESOURCES”, where Q-context transform processing resources such as rules and/or map-reduce transforms may be created. Block 628 may be followed by block 630, “REGISTER SEMANTIC OBJECTS”, where the semantic objects may be registered by asserting them when the semantic cache is active in the network, explicitly or implicitly.

The operations included in the processes of FIG. 5 and FIG. 6 described above are for illustration purposes. Semantic cache cloud services for connected devices may be implemented by similar processes with fewer or additional operations. In some examples, the operations may be performed in a different order. In some other examples, various operations may be eliminated. In still other examples, various operations may be divided into additional operations, or combined together into fewer operations. Although illustrated as sequentially ordered operations, in some implementations the various operations may be performed in a different order, or in some cases various operations may be performed at substantially the same time.

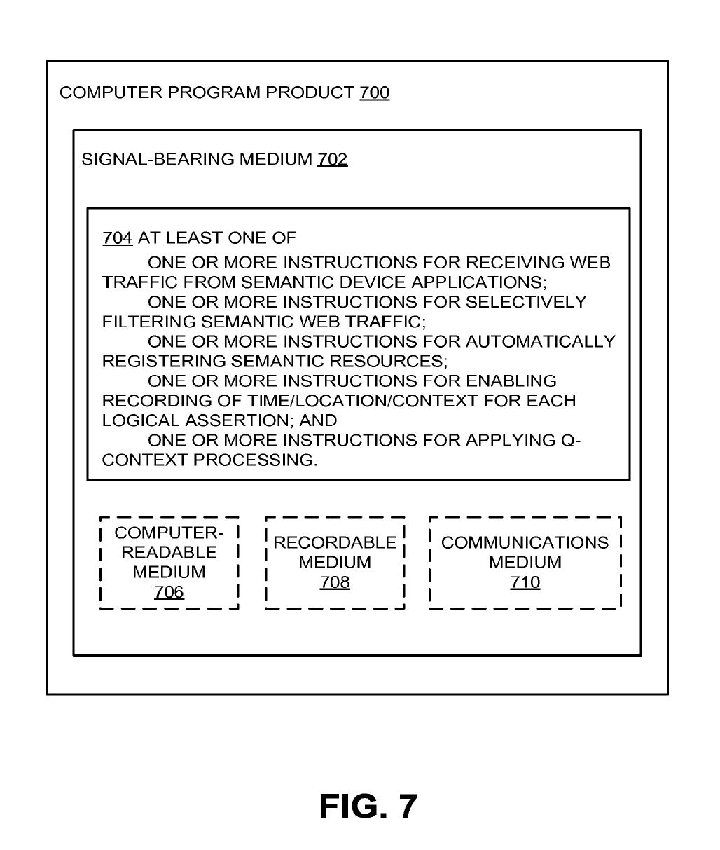

FIG. 7 illustrates a block diagram of an example computer program product, arranged in accordance with at least some embodiments described herein. In some examples, as shown in FIG. 7, a computer program product 700 may include a signal bearing medium 702 that may also include machine readable instructions 704 that, when executed by, for example, a processor, may provide the functionality described above with respect to FIG. 1 through FIG. 3. Thus, for example, referring to the processor 404, one or more of the tasks shown in FIG. 7 may be undertaken in response to instructions 704 conveyed to the processor 404 by the medium 702 to perform actions associated with providing semantic cache cloud services to connected devices as described herein. Some of those instructions may include receiving web traffic from semantic device applications, selectively filtering semantic web traffic, automatically registering semantic resources, enabling recording of time/location/context for each logical assertion, and applying Q-context processing.

In some implementations, the signal bearing medium 702 depicted in FIG. 7 may encompass a computer-readable medium 706, such as, but not limited to, a hard disk drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, computer program product 700 may be conveyed to the processor 704 by an RF signal bearing medium, where the signal bearing medium 702 is conveyed by a wireless communications medium 710 (e.g., a wireless communications medium conforming with the IEEE 802.11 standard).

According to some embodiments, a method for providing semantic cache cloud services to connected devices may include receiving, by a caching reverse proxy server, web traffic from semantic device applications; selectively filtering the received web traffic; and automatically registering semantic objects representing semantic devices and semantic device applications into one or more namespaces. The method may also include instrumenting the received web traffic such that one or more of a time, a location, and a context for logical assertions are recorded, where the semantic objects are represented as a collection of logical assertions; and coordinating and synchronizing the semantic objects within a semantic object plexus representing cooperating semantic devices and semantic device applications.

In some examples, the method may further include one or more of identifying, locating, tracking, and determining a security status of the semantic devices and the semantic device applications. Requests from the semantic device applications may be served directly by a semantic cache if the semantic cache is available or fetched from a semantic web of linked data and then served from the semantic cache to the semantic device applications if the semantic cache is not available. The method may also include selectively filtering the received web traffic employing one or more of a dynamically created and updated semantic web linked data namespace, a global public data registry, and/or a private data registry.

In other examples, automatically registering the semantic objects into one or more namespaces may include registering semantic resources, caches, and proxy detected semantic web namespace traffic into one of: a public cached namespace, a private shadow namespace, and/or an activated private Q-context namespace. The public cached namespace may represent reachable semantic web linked data resources, and wherein the reachable semantic web linked data resources are cached, controlled, and managed via policies governing the semantic cache upon being accessed. The private shadow namespace may include a shadow copy of the public cached namespace such that each semantic object referenced in the namespace is automatically instrumented by temporal, geospatial, and contextual versioning.

In further examples, the activated private Q-context namespace may be a secure namespace that is opaque to users and includes controls and manages q-context processing. The Q-context may include a predefined set of objects, properties, and values that define assertions, queries, and rules relevant to an instrumented object represented by an OBJECT-PROPERTY-VALUE assertion, where OBJECT refers to a reference to a semantic object, PROPERTY is the reference to a property of the semantic object in a given namespace, and VALUE is one of a reference, a scalar value, or an aggregate value. Each OBJECT-PROPERTY-VALUE assertion may be instrumented with one or more TIME-LOCATION-Q Context assertions, where TIME is a universal time designation with a predefined precision and LOCATION is a set of geospatial coordinates of a predefined precision that locates one of a shape or point in space.

In further examples, coordinating and synchronizing the semantic objects within a semantic object plexus may include applying Q-contextual assertions, queries, and rules for a predefined interlock and creating a semantic plexus if predefined interlock conditions are met. The method may also include performing on the semantic plexus one or more of a semantic web inference engines, a logic reasoner, and/or a semantic web map-reduce framework. The method may further include prioritizing and optimizing computations based on an availability of semantic web resources and/or automatically optimizing semantic device application access and response based on semantics of each semantic device application in terms of Q-context assertions, queries, and rules detected when the semantic device application is first used.

In yet further examples, the method may include enabling a web device application developer to extend the semantic objects in a private shadow namespace; create secure semantic objects in a private Q-context namespace; create one or more Q-contexts for semantic plexus interlock device object groups clustered by one or more of time, location proximity, Q-context value preconditions, and/or Q-context value thresholds; create Q-context transform processing resources including rules and/or map-reduce transforms; and register the semantic objects by asserting through explicit or implicit assertion when a semantic cache is active in a network.

According to other embodiments, a server for providing semantic cache cloud services to connected devices may include a memory adapted to store instructions, a communication module, and a processor adapted to communicate with the connected devices via one or more networks in conjunction with the stored instructions. The processor may receive web traffic from semantic device applications; selectively filter the received web traffic; automatically register semantic objects representing semantic devices and semantic device applications into one or more namespaces; instrument the received web traffic such that one or more of a time, a location, and a context for logical assertions are recorded, where the semantic objects are represented as a collection of logical assertions; and coordinate and synchronize the semantic objects within a semantic object plexus representing cooperating semantic devices and semantic device applications.

In some examples, the processor may identify, locate, track, and determine a security status of the semantic devices and/or the semantic device applications. Requests from the semantic device applications may be served directly by a semantic cache if the semantic cache is available or fetched from a semantic web of linked data and then served from the semantic cache to the semantic device applications if the semantic cache is not available. The processor may also selectively filter the received web traffic employing one or more of a dynamically created and updated semantic web linked data namespace, a global public data registry, and/or a private data registry.

In other examples, the processor may automatically register the semantic objects into one or more namespaces by registering semantic resources, caches, and proxy detected semantic web namespace traffic into one of: a public cached namespace, a private shadow namespace, and/or an activated private Q-context namespace. The public cached namespace may represent reachable semantic web linked data resources, and where the reachable semantic web linked data resources are cached, controlled, and managed via policies governing the semantic cache upon being accessed. The private shadow namespace may include a shadow copy of the public cached namespace such that each semantic object referenced in the namespace is automatically instrumented by temporal, geospatial, and contextual versioning.

In further examples, the activated private Q-context namespace may be a secure namespace that is opaque to users and includes controls and manages Q-context processing. The Q-context may include a predefined set of objects, properties, and values that define assertions, queries, and rules relevant to an instrumented object represented by an OBJECT-PROPERTY-VALUE assertion, where OBJECT refers to a reference to a semantic object, PROPERTY is the reference to a property of the semantic object in a given namespace, and VALUE is one of a reference, a scalar value, or an aggregate value. Each OBJECT-PROPERTY-VALUE assertion may be instrumented with one or more TIME-LOCATION-Q Context assertions, where TIME is a universal time designation with a predefined precision and LOCATION is a set of geospatial coordinates of a predefined precision that locates one of a shape or point in space. The processor may coordinate and synchronize the semantic objects within a semantic object plexus by applying Q-contextual assertions, queries, and rules for a predefined interlock and creating a semantic plexus if predefined interlock conditions are met.

In yet other examples, the processor may perform on the semantic plexus one or more of a semantic web inference engines, a logic reasoner, and/or a semantic web map-reduce framework; prioritize and optimize computations based on an availability of semantic web resources; and/or automatically optimize semantic device application access and response based on semantics of each semantic device application in terms of Q-context assertions, queries, and rules detected when the semantic device application is first used. The processor may enable a web device application developer to extend the semantic objects in a private shadow namespace; create secure semantic objects in a private Q-context namespace; create one or more Q-contexts for semantic plexus interlock device object groups clustered by one or more of time, location proximity, Q-context value preconditions, and/or Q-context value thresholds; create Q-context transform processing resources including rules and/or map-reduce transforms; and register the semantic objects by asserting through explicit or implicit assertion when a semantic cache is active in a network.

According to further embodiments, a computer-readable medium may include instructions stored thereon for providing semantic cache cloud services to connected devices. The instructions may include receiving, by a caching reverse proxy server, web traffic from semantic device applications; selectively filtering the received web traffic; automatically registering semantic objects representing semantic devices and semantic device applications into one or more namespaces; instrumenting the received web traffic such that one or more of a time, a location, and a context for logical assertions are recorded, where the semantic objects are represented as a collection of logical assertions; and coordinating and synchronizing the semantic objects within a semantic object plexus representing cooperating semantic devices and semantic device applications.

In some examples, the instructions may further include one or more of identifying, locating, tracking, and determining a security status of the semantic devices and the semantic device applications. Requests from the semantic device applications may be served directly by a semantic cache if the semantic cache is available or fetched from a semantic web of linked data and then served from the semantic cache to the semantic device applications if the semantic cache is not available. The instructions may further include selectively filtering the received web traffic employing one or more of a dynamically created and updated semantic web linked data namespace, a global public data registry, and/or a private data registry.

In other examples, automatically registering the semantic objects into one or more namespaces may include registering semantic resources, caches, and proxy detected semantic web namespace traffic into one of: a public cached namespace, a private shadow namespace, and/or an activated private Q-context namespace. The public cached namespace may represent reachable semantic web linked data resources, and where the reachable semantic web linked data resources are cached, controlled, and managed via policies governing the semantic cache upon being accessed. The private shadow namespace may include a shadow copy of the public cached namespace such that each semantic object referenced in the namespace is automatically instrumented by temporal, geospatial, and contextual versioning.

In further examples, the activated private Q-context namespace is a secure namespace that is opaque to users and includes controls and manages Q-context processing. The Q-context may include a predefined set of objects, properties, and values that define assertions, queries, and rules relevant to an instrumented object represented by an OBJECT-PROPERTY-VALUE assertion, where OBJECT refers to a reference to a semantic object, PROPERTY is the reference to a property of the semantic object in a given namespace, and VALUE is one of a reference, a scalar value, or an aggregate value. Each OBJECT-PROPERTY-VALUE assertion may be instrumented with one or more TIME-LOCATION-Q Context assertions, where TIME is a universal time designation with a predefined precision and LOCATION is a set of geospatial coordinates of a predefined precision that locates one of a shape or point in space.

In yet other examples, coordinating and synchronizing the semantic objects within a semantic object plexus may include applying Q-contextual assertions, queries, and rules for a predefined interlock and creating a semantic plexus if predefined interlock conditions are met. The instructions may also include one or more of performing on the semantic plexus one or more of a semantic web inference engines, a logic reasoner, and/or a semantic web map-reduce framework; prioritizing and optimizing computations based on an availability of semantic web resources; and/or automatically optimizing semantic device application access and response based on semantics of each semantic device application in terms of Q-context assertions, queries, and rules detected when the semantic device application is first used. The instructions may further include enabling a web device application developer to extend the semantic objects in a private shadow namespace; create secure semantic objects in a private Q-context namespace; create one or more Q-contexts for semantic plexus interlock device object groups clustered by one or more of time, location proximity, Q-context value preconditions, and/or Q-context value thresholds; create Q-context transform processing resources including rules and/or map-reduce transforms; and register the semantic objects by asserting through explicit or implicit assertion when a semantic cache is active in a network.

According to yet other embodiments, a system for providing semantic cache cloud services to connected devices may include a semantic cache service executed by one or more servers. The semantic cache service may include a semantic cache proxy service configured to one or more of register, identify, locate, track, and manage security of the connected devices' and/or connected device applications' metadata projection into a semantic cloud. The semantic cache service may also include a semantic cache interlock service configured to coordinate and synchronize semantic objects within a semantic object plexus that represents cooperating connected devices and connected device applications and a semantic cache transform service configured to provide transactional object transformations within and between interlocked semantic objects and/or semantic plexii.

In some examples, the semantic cache proxy service may receive web traffic from the connected device applications; selectively filter the received web traffic; automatically register the semantic objects representing the connected devices and the connected device applications into one or more namespaces; and instrument the received web traffic such that one or more of a time, a location, and a context for logical assertions are recorded, where the semantic objects are represented as a collection of logical assertions. The semantic objects may be registered into one or more of: a public cached namespace, a private shadow namespace, and/or an activated private Q-context namespace, where the public cached namespace represents reachable semantic web linked data resources and the reachable semantic web linked data resources are cached, controlled, and managed via policies governing the semantic cache service upon being accessed; the private shadow namespace includes a shadow copy of the public cached namespace such that each semantic object referenced in the namespace is automatically instrumented by temporal, geospatial, and contextual versioning; and the activated private Q-context namespace is a secure namespace that is opaque to users and includes controls and manages q-context processing.

In other examples, the semantic cache proxy service may automatically optimize connected device application access and response based on semantics of each connected device application in terms of Q-context assertions, queries, and rules detected when the connected device application is first used, where the Q-context includes a predefined set of objects, properties, and values that define assertions, queries, and rules relevant to an instrumented object represented by an OBJECT-PROPERTY-VALUE assertion, where OBJECT refers to a reference to a semantic object, PROPERTY is the reference to a property of the semantic object in a given namespace, and VALUE is one of a reference, a scalar value, or an aggregate value.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one skilled in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for providing semantic cache cloud services to connected devices, comprising:
receiving, by a caching reverse proxy server, web traffic from semantic device applications;
selectively filtering the received web traffic;
automatically registering semantic objects representing semantic devices and semantic device applications into one or more namespaces;
instrumenting the received web traffic such that one or more of a time, a location, and a context for logical assertions are recorded, wherein the semantic objects are represented as a collection of logical assertions; and
coordinating and synchronizing the semantic objects within a semantic object plexus representing cooperating semantic devices and semantic device applications.

2. The method according to claim 1, further comprising one or more of identifying, locating, tracking, and determining a security status of the semantic devices and the semantic device applications.

3. The method according to claim 1, wherein requests from the semantic device applications are served directly by a semantic cache if the semantic cache is available or fetched from a semantic web of linked data and then served from the semantic cache to the semantic device applications if the semantic cache is not available.

4. The method according to claim 1, further comprising:
selectively filtering the received web traffic employing one or more of a dynamically created and updated semantic web linked data namespace, a global public data registry, and/or a private data registry.

5. The method according to claim 1, wherein automatically registering the semantic objects into one or more namespaces comprises:
registering semantic resources, caches, and proxy detected semantic web namespace traffic into one of: a public cached namespace, a private shadow namespace, and/or an activated private Q-context namespace.

6. The method according to claim 5, wherein the public cached namespace represents reachable semantic web linked data resources, and wherein the reachable semantic web linked data resources are cached, controlled, and managed via policies governing the semantic cache upon being accessed.

7.-16. (canceled)

17. A server for providing semantic cache cloud services to connected devices, comprising:
a memory adapted to store instructions;
a communication module; and
a processor adapted to communicate with the connected devices via one or more networks in conjunction with the stored instructions, wherein the processor is configured to:
receive web traffic from semantic device applications;
selectively filter the received web traffic;
automatically register semantic objects representing semantic devices and semantic device applications into one or more namespaces;
instrument the received web traffic such that one or more of a time, a location, and a context for logical assertions are recorded, wherein the semantic objects are represented as a collection of logical assertions; and
coordinate and synchronize the semantic objects within a semantic object plexus representing cooperating semantic devices and semantic device applications.

18.-20. (canceled)

21. The server according to claim 17, wherein the processor is configured to automatically register the semantic objects into one or more namespaces by:
registering semantic resources, caches, and proxy detected semantic web namespace traffic into one of: a public cached namespace, a private shadow namespace, and/or an activated private Q-context namespace.

22. (canceled)

23. The server according to claim 22, wherein the private shadow namespace includes a shadow copy of the public cached namespace such that each semantic object referenced in the namespace is automatically instrumented by temporal, geospatial, and contextual versioning.

24. The server according to claim 21, wherein the activated private Q-context namespace is a secure namespace that is opaque to users and includes controls and manages Q-context processing.

25. The server according to claim 24, wherein the Q-context includes a predefined set of objects, properties, and values that define assertions, queries, and rules relevant to an instrumented object represented by an OBJECT-PROPERTY-VALUE assertion.

26. The server according to claim 25, wherein OBJECT refers to a reference to a semantic object, PROPERTY is the reference to a property of the semantic object in a given namespace, and VALUE is one of a reference, a scalar value, or an aggregate value.

27. The server according to claim 25, wherein each OBJECT-PROPERTY-VALUE assertion is instrumented with one or more TIME-LOCATION-Q Context assertions, where TIME is a universal time designation with a predefined precision and LOCATION is a set of geospatial coordinates of a predefined precision that locates one of a shape or point in space.

28.-32. (canceled)

33. A computer-readable medium with instructions stored thereon for providing semantic cache cloud services to connected devices, the instructions comprising:
receiving, by a caching reverse proxy server, web traffic from semantic device applications;
selectively filtering the received web traffic;
automatically registering semantic objects representing semantic devices and semantic device applications into one or more namespaces;
instrumenting the received web traffic such that one or more of a time, a location, and a context for logical assertions are recorded, wherein the semantic objects are represented as a collection of logical assertions; and
coordinating and synchronizing the semantic objects within a semantic object plexus representing cooperating semantic devices and semantic device applications.

34.-43. (canceled)

44. The computer-readable medium according to claim 33, wherein coordinating and synchronizing the semantic objects within a semantic object plexus comprises applying Q-contextual assertions, queries, and rules for a predefined interlock and creating a semantic plexus if predefined interlock conditions are met.

45. The computer-readable medium according to claim 44, wherein the instructions further comprise:
performing on the semantic plexus one or more of a semantic web inference engines, a logic reasoner, and/or a semantic web map-reduce framework.

46. The computer-readable medium according to claim 33, wherein the instructions further comprise:
prioritizing and optimizing computations based on an availability of semantic web resources.

47. The computer-readable medium according to claim 33, wherein the instructions further comprise:
automatically optimizing semantic device application access and response based on semantics of each semantic device application in terms of Q-context assertions, queries, and rules detected when the semantic device application is first used.

48. The computer-readable medium according to claim 33, wherein the instructions further comprise:
enabling a web device application developer to:
extend the semantic objects in a private shadow namespace;
create secure semantic objects in a private Q-context namespace;
create one or more Q-contexts for semantic plexus interlock device object groups clustered by one or more of time, location proximity, Q-context value preconditions, and/or Q-context value thresholds;
create Q-context transform processing resources including rules and/or map-reduce transforms; and
register the semantic objects by asserting through explicit or implicit assertion when a semantic cache is active in a network.

49. A system for providing semantic cache cloud services to connected devices, the system comprising:
a semantic cache service configured to be executed by one or more servers, wherein the semantic cache service includes:
a semantic cache proxy service configured to one or more of register, identify, locate, track, and manage security of the connected devices' and/or connected device applications' metadata projection into a semantic cloud;
a semantic cache interlock service configured to coordinate and synchronize semantic objects within a semantic object plexus that represents cooperating connected devices and connected device applications; and
a semantic cache transform service configured to provide transactional object transformations within and between interlocked semantic objects and/or semantic plexii.

50. The system of claim 49, wherein the semantic cache proxy service is further configured to:
receive web traffic from the connected device applications;
selectively filter the received web traffic;
automatically register the semantic objects representing the connected devices and the connected device applications into one or more namespaces; and
instrument the received web traffic such that one or more of a time, a location, and a context for logical assertions are recorded, wherein the semantic objects are represented as a collection of logical assertions.

51. The system of claim 49, wherein the semantic objects are registered into one or more of: a public cached namespace, a private shadow namespace, and/or an activated private Q-context namespace, where:
the public cached namespace represents reachable semantic web linked data resources and the reachable semantic web linked data resources are cached, controlled, and managed via policies governing the semantic cache service upon being accessed;
the private shadow namespace includes a shadow copy of the public cached namespace such that each semantic object referenced in the namespace is automatically instrumented by temporal, geospatial, and contextual versioning; and
the activated private Q-context namespace is a secure namespace that is opaque to users and includes controls and manages q-context processing.

52. The system of claim 49, wherein the semantic cache proxy service is further configured to:
automatically optimize connected device application access and response based on semantics of each connected device application in terms of Q-context assertions, queries, and rules detected when the connected device application is first used.

53. The system of claim 52, wherein the Q-context includes a predefined set of objects, properties, and values that define assertions, queries, and rules relevant to an instrumented object represented by an OBJECT-PROPERTY-VALUE assertion, where OBJECT refers to a reference to a semantic object, PROPERTY is the reference to a property of the semantic object in a given namespace, and VALUE is one of a reference, a scalar value, or an aggregate value.
